(19) United States
(12) Patent Application Publication
(10) Pub. No.: US 2021/0141199 A1
(43) Pub. Date: May 13, 2021

(54) SMALL SCALE LIGHT PROJECTION DEVICE FACILITATING THE STRUCTURING OF LIGHT EMITTED FOR DEPTH-CALCULATING PURPOSES

(71) Applicant: TRIPLE WIN TECHNOLOGY(SHENZHEN) CO.LTD., Shenzhen (CN)

(72) Inventors: WEI-WEI QI, Shenzhen (CN); CHING-HUANG LIN, Taoyuan (TW)

(21) Appl. No.: 16/738,149

(22) Filed: Jan. 9, 2020

(30) Foreign Application Priority Data
Nov. 8, 2019 (CN) 201911085528.2

(51) Int. Cl. G02B 17/00; G02B 27/30; G02B 27/42

(52) U.S. Cl. CPC G02B 17/006; G01C 3/02; G02B 27/425; G02B 27/30

(57) ABSTRACT

A small-scale light projection device emitting structured light for better spot optimization includes a light emitting assembly, an optical path changing unit, and a diffractive optical element. The optical path changing unit of the device is arranged on a light path of the light emitting assembly and applies several changes to the direction of transmission of light within a small space. The diffractive optical element is arranged on a final light path of the optical path changing unit and opposite to the light emitting assembly and applies patterns to the light beam. The optical path changing unit comprises several reflection portions, enabling changes to be made to the light transmission direction.

The subject matter herein generally relates to optical devices, in particular relates to a structured light projection device.

### BACKGROUND

Depth camera realizes 3D scanning, scene modeling, and gesture interaction by calculating different depths. For example, the combination of depth camera, TV, computer, and so on can realize somatosensory game to achieve the effect of game and fitness. A core component of a depth camera is optical projection module. In order to acquire information as to depths, the depth camera based on structured light principle includes light emission module which produces a specific type of structured light. The structured light projection module is generally composed of light source, collimation module, and diffractive optical module (DOE). When the light is emitted, spot optimization can be realized for short distances, but in order to increase the optical path distance, the structure and volume of the product must be increased, this is not convenient for lightweight and miniaturized design.

### BRIEF DESCRIPTION OF THE DRAWINGS

Implementations of the present technology will now be described, by way of embodiments, with reference to the attached figures.

FIG. 1 is an isometric view of a structured light projection device in accordance with one exemplary embodiment.

FIG. 2 is an isometric view of a structured light projection device in accordance with one exemplary embodiment.

FIG. 3 is a cross-sectional view of the structured light projection device in FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain portions may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like. The references “a plurality of” and “a number of” mean “at least two.”

FIG. 1 illustrates a structured light projection device 100 according to a first embodiment. The structured light projection device 100 is used for depth perception. The structured light projection device 100 includes a light emitting assembly 1, a collimation element 2, an optical path changing unit 3, and a diffractive optical element 4.

The light emitting assembly 1 emits light. The light emitting assembly 1 can be either a single light source or multiple light sources. Among them, vertical cavity surface emitting laser (VCSEL) is more suitable for use in structured light projection devices because of its small volume, small divergence angle, and stability. A VCSEL array as the light source increases projection intensity.

In the present embodiment, the light emitting assembly 1 is a two-dimensional VCSEL chip, the VCSEL chip includes at least one VCSEL light source capable of projecting infrared beams of 830 nm or 950 nm wavelength. The VCSEL array light source can control independent light emission of each VCSEL through packet control, and the packet control can be applied in any form, such as independently controlling several of the light sources or all the light sources at the same time, thereby realizing a different beam shape, different sizes of patterns, or light densities.

In this embodiment, the light emitting assembly 1 is mounted on the substrate 11. The substrate 11 is a printed circuit board.

The collimation element 2 is arranged on a light path of the light emitting assembly 1, and laser emitted from the light emitting assembly 1 is incident on the collimation element 2. The collimation element 2 collimates light rays from the light assembly 1. In the embodiment, the collimation element 2 is a convex lens. The structured light projection device 100 may include more than one collimation element 2.

The optical path changing unit 3 is arranged on a light path of the collimation element 2 and changes transmission direction of the collimated light from the collimation element 2. The light path changing unit 3 can change transmission direction of the light at least three times and, an emitting direction of the light after the last change of the transmission direction is parallel to a direction emitted from the light emitting assembly 1.

The optical path changing unit 3 includes a plurality of reflection portions. The reflection portions can be a reflecting plate or a plane mirror. In this embodiment, the optical path changing unit 3 includes a first reflection portion 31 facing the light emitting assembly 1, a second reflection portion 32 facing the diffractive optical element 4, and at least one third reflection portion 33 arranged on a light path between the first reflection portion 31 and the second reflection portion 32.

In this embodiment, the first reflection portion 31 is parallel to the second reflection portion 32.

In this embodiment, the optical path changing unit 3 includes a first reflection portion 31, a second reflection portion 32, and two third reflection portions 33. The two third reflection portions 33 are parallel to each other. In other embodiment, the optical path changing unit 3 may include a first reflection portion 31, a second reflection portion 32, and only one reflection portion 33.

One end of the third reflection portion 33 is connected to the first reflection portion 31, and the other end of the third reflection portion 33 is spaced apart from the second reflection portion 32. The first reflection portion 31, the second reflection portion 32, the two third reflection portions 33, and the diffractive optical element 4 roughly form a box structure (a “ [symbol] ” structure).

An angle β formed between the first reflection portion 31 and the third reflection portion 33 is in a range of 90°<β<135°. The transmission direction of the laser emitted from the collimation element 2 is changed through the first reflection portion 31, the two third reflection portions 33, and the second reflection portion 32 in turn.

The angle β between the first reflection portion 31 and the second reflection portion 32 is limited in a range of 90°<β<135, thereby the light is incident to the second reflection portion 32 after being reflected by the first reflection portion 31 and reflected by the second reflection portion 32 to the third reflection portion 33.

The laser emitted by the light emitting assembly 1 is incident to the diffractive optical element 4 after the reflection of the first reflection portion 31, the second reflection portion 32, and the third reflection portion 33 in turn.

The laser emitted by the light emitting assembly 1 is reflected by the first reflection portion 31, the two third reflection portions 33, and the second reflection portion 32 in turn, and then incident to the diffractive optical element 4 after the transmission direction transmission is changed many times.

The diffractive optical element (DOE) 4 receives parallel beams projected by the optical path changing unit 3 and projects a patterned beam with uniform energy distribution and high contrast through mirror image superposition. Uniform or structured light fields can be generated efficiently by using diffractive optical elements 4 for beam shaping. The diffractive optical element 4 is arranged on the opposite side of the light emitting assembly 1 and faces the third reflection portion 33. The diffractive optical element 4 receives light after the optical path changing unit 3 changes an optical path transmission direction. The diffractive optical element 4 can be made from glass material or polymer (plastic) material. The diffractive optical element 4 is generally fabricated by electron beam direct writing technology or other feasible means to etch irregular gratings on the transparent substrate surface of glass or plastic material to depth of 1 um.

In this embodiment, the light path L of the laser emitted by the light emitting assembly 1 is: L=M1+M2+M3+M4+M5. In the prior art, the laser emitted by the light emitting assembly 1 incident to the diffractive optical element 4 is M1+M5. In this disclosure, without increasing the size or volume of the structured light projector 100, the optical path of the laser can be increased by a certain distance, and the spot optimization is better realized.

FIGS. 2-3 illustrate a structured light projection device 200 according to a second embodiment. The structured light projection device 200 in FIGS. 2-3 is similar to the structured light projection device 100 in FIG. 1. The structured light projection device 200 also includes a light emitting assembly 1, a collimation element 2, an optical path changing unit 3, and a diffractive optical element 4.

The difference between the structured light projection device 200 and the structured light projection device 100 in FIG. 1 is that the structured light projection device 200 includes a transparent carrier 5.

The carrier 5 is fixed to the substrate 11 through an adhesive layer 6. The optical path changing element 3 is arranged on the carrier 5. The collimation element 2 and the carrier 5 can be integrally formed in a mold.

The carrier 5 is made from a material selected from a group consisting of polyethylene terephthalate, polymethyl methacrylate, polycarbonate, and polyimide.

Preferably, the carrier 5 includes a cavity 50. The cavity 50 includes a first connection surface 51, a second connection surface 52, a third connection surface 53, and a fourth connection surface 54. The first reflection portion 31, the second reflection portion 32, and the two third reflection portions 33 are respectively formed on the first connection surface 51, the third connection surface 53, the second connection surface 52, and the fourth connection surface 54.

Preferably, the first reflection portion 31, the second reflection portion 32, and the two third reflection portions 33 are reflective coatings, such as silver coating formed on the first connection surface 51, the third connection surface 53, the second connection surface 52, and the fourth connection surface 54.

Preferably, the first reflection portion 31, the second reflection portion 32, and the two third reflection portions 33 are reflecting mirrors respectively mounted on the first connecting surface 51, the third connecting surface 53, the second connecting surface 52, and the fourth connecting surface 54.

The structured light projection device 100 (200) provided by the disclosure does not increase an overall size of the structured light projection device 100 (200), and increases the number of reflections of light to increase the optical path, so as to realize the optimization of the spot.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the portions within the principles of the present disclosure, up to and including the full extent established by the broad general meaning of the terms used in the claims. It will therefore be appreciated that the embodiments described above may be modified within the scope of the claims.

What is claimed is:

1. A structured light projection device, comprising:
a light emitting assembly for emitting light;
an optical path changing unit is arranged on a light path of the light emitting assembly for changing transmission direction of light; and
a diffractive optical element arranged on a light path of the optical path changing unit and opposite to the light emitting assembly; wherein the optical path changing unit comprises a plurality of reflection portions, and the plurality of reflection portion comprises a first reflection portion tilt facing the light emitting assembly, a second reflection portion tilt facing the diffractive optical element, and at least one third reflection portion arranged on a light path between the first reflection portion and the second reflection portion, an emitting light from the second reflection portion is parallel to an light emitting form the light emitting assembly.

2. The structured light projection device of claim 1, wherein the first reflection portion is parallel to the second reflection portion.

3. The structured light projection device of claim 1, wherein the optical path changing unit comprises two third reflection portions, the two third reflection portions are parallel to each other.

4. The structured light projection device of claim 3, wherein the first reflection portion, the second reflection portion, two of the third reflection portion and the diffractive optical element substantially form a “ [symbol] ” structure.

5. The structured light projection device of claim 4, wherein a obtuse angle β formed between the first reflection portion and one third reflection portion is in a range of 90°<β<135°.

6. The structured light projection device of claim 5, wherein further comprises a collimation element arranged on a light path between the light emitting assembly and the optical path changing unit.

7. The structured light projection device of claim 6, further comprises a substrate, and the light emitting assembly is mounted on the substrate.

8. The structured light projection device of claim 7, further comprises a transparent carrier for holding the optical path changing element.

9. The structured light projection device of claim 8, wherein the carrier is fixed to the substrate through an adhesive layer, the carrier comprise a cavity, the collimation element protrudes into the cavity, and the optical path changing unit is arranged on side surfaces of the cavity.

10. The structured light projection device of claim 9, wherein the carrier is made from a material selected from a group consisting of polyethylene terephthalate, polymethyl methacrylate, polycarbonate and polyimide.

11. The structured light projection device of claim 10, wherein the cavity comprises a first connection surface, a second connection surface, a third connection surface and a fourth connection surface, the first reflection portion, the second reflection portion, the two third reflection portions are formed on the first connection surface, the third connection surface and the second connection surface, and the fourth connection surface, respectively.

12. The structured light projection device of claim 11, wherein the collimation element and the carrier are integrally formed in a mold.

13. A structured light projection device, comprising:
a light emitting assembly for emitting light;
a transparent carrier defines an cavity;
an optical path changing unit is arranged in the cavity and located on a light path of the light emitting assembly for changing transmission direction of the light; and
a diffractive optical element arranged on a light path of the optical path changing unit and opposite to the light emitting assembly; wherein the optical path changing unit comprises a plurality of reflection portions, and the plurality of reflection portion comprises a first reflection portion tilt facing the light emitting assembly, a second reflection portion tilt facing the diffractive optical element, and at least one third reflection portion arranged on a light path between the first reflection portion and the second reflection portion, and emitting light from the second reflection portion is parallel to an light emitting form the light emitting assembly.

14. The structured light projection device of claim 13, wherein the optical path changing unit is a reflective coating formed on surface of the cavity or reflecting mirror mounted on surface of the cavity.

15. The structured light projection device of claim 14, wherein the first reflection portion is parallel to the second reflection portion.

16. The structured light projection device of claim 15, wherein the optical path changing unit comprises two third reflection portions, the two third reflection portions are parallel to each other.

17. The structured light projection device of claim 16, wherein the first reflection portion, the second reflection portion, two of the third reflection portion and the diffractive optical element substantially form a “ [symbol] ” structure.

18. The structured light projection device of claim 17, wherein a obtuse angle β formed between the first reflection portion and one third reflection portion is in a range of 90°<β<135°.

19. The structured light projection device of claim 18, wherein further comprises a collimation element arranged on a light path between the light emitting assembly and the optical path changing unit.

20. The structured light projection device of claim 19, further comprises a substrate, and the light emitting assembly is mounted on the substrate.
